(19) United States
(12) Patent Application Publication
(10) Pub. No.: US 2026/0182780 A1
(43) Pub. Date: Jul. 2, 2026

(54) Automated Food Frying Machine for use in Retail Locations

(71) Applicant: My Fry Inc., Toronto (CA)

(72) Inventor: Mark Fuerst, Toronto (CA)

(73) Assignee: My Fry Inc., Toronto (CA)

(21) Appl. No.: 19/006,806

(22) Filed: Dec. 31, 2024

(51) Int. Cl. A47J 37/12

(52) U.S. Cl. CPC A47J 37/1266; A47J 37/1219; A47J 37/1228; A47J 37/1261; A47J 37/1295; A47J 2202/00; A47J 2203/00

(57) ABSTRACT

A machine for frying food at a retail location is provided. The machine comprises: an optical reader; a display; a chute to receive the food products from the package; an oil pan; a heating coil unit moveable to locations in and away from the oil pan; a first motor connected to the heating coil unit; a moveable basket to receive the food products from the chute, the basket moveable amongst locations within the machine during a food cooking cycle; a second motor connected to arms connected to the basket to controllably move the basket; and a control module to control the first motor to set the location of the heating coil, control the second motor to set the location and movements of the moveable basket, track and monitor oil usage; and track and monitor food products processed over a period of time.

### FIELD OF DISCLOSURE

The present disclosure relates generally to food frying machines.

### BACKGROUND OF THE DISCLOSURE

Convenience store retailers offer pre-cooked and heated food products (e.g. hot dogs, pizza slices) that are cooked and kept warm on hot dog cookers and other food heating machines. Current machines do not provide for cooking of other fried food products, such as French fries.

### SUMMARY OF THE DISCLOSURE

In one aspect of an embodiment, a machine for frying food at a retail location is provided. The machine comprises: an optical reader to scan and read a product code from a package of food products; a display; a chute to receive the food products from the package; an oil pan; a heating coil unit locatable within the oil pan and moveable to a location away from the oil pan; a first motor connected to the heating coil unit to controllably move the heating coli unit; a moveable basket to receive the food products from the chute, the basket moveable amongst a first location within the machine to receive the food products, a second location to be immersed within oil in the oil pan for cooking the food products, a third location to be raised above the oil pan after the food products are cooked, and a fourth location to dispense the cooked food products to a container; a second motor connected to arms connected to the basket to controllably move the basket; and a control module to control the first motor to set the location of the heating coil, control the second motor to set the location and movements of the moveable basket, track and monitor oil usage; and track and monitor food products processed over a period of time. For the machine, the package of food products is one variety in a plurality of packages of food products.

The machine may further comprise an air ventilation and cleaning system. The system may comprise: first and second filters; a mesh filter; a plurality of fans; and a series of air vents and channels along the cabinet walls of the machine to facilitate air flow within the machine.

In the machine, the control module may further control the activation of the coils to keep the coils activated during opening business hours for the retail location.

In the machine, the control module may further control the second motor when the basket is at the third location raised above the oil pan after the food products to hold the basket at the third location to facilitate excess oil on the products to drain from the basket.

In the machine, the control module may further control the second motor when the basket is at the fourth location dispensing the cooked food products to the container to oscillate the basket back and forth about the fourth location to cause any stuck food products to fall from the basket.

In the machine, the heating coil unit may comprise: a heating coil; a first thermostat positionable at a first depth in the oil pan; and a second thermostat positionable at a second depth in the oil pan. The control module may analyze temperature readings from the first and second thermostats to determine a level of oil in the oil pan.

In the machine, the control module may have a cleaning cycle for the machine. The cleaning cycle may: monitor for a threshold of either a time since last cleaning and cycles of food products processed is since the last cleaning; upon the threshold being reached, start the cleaning cycle by activating a lock for a front door of the machine, displaying a message on the display indicating that the cleaning cycle has been initiated, lifting the heating coil unit out of the oil pan, turning off the heating coil unit, and starting a timer to track the cooling time for the oil; and upon a threshold of time being passed for the timer deactivate the lock for the front door and display a message on the display indicating that the cleaning cycle completed.

In the machine, the control module may further generate a report of the food products processed over the period of time; and transmit the report to a remote location over a communication link.

In the machine, the control module may further track for operating error conditions in the machine; and transmit an error condition report to a remote location over a communication link.

In the machine, the control module may further generate a sales report of the food product currently being processed; and transmit the report to a point of sales terminal location over a communication link.

In other aspects, various combinations of sets and subsets of the above aspects are provided.

### BRIEF DESCRIPTION OF THE DRAWINGS

The foregoing and other aspects of the disclosure will become more apparent from the following description of specific embodiments thereof and the accompanying drawings which illustrate, by way of example only, principles of the disclosure. In the drawings:

FIG. 1a shows front and side views of a machine according to one embodiment;

FIG. 1b is a skeleton perspective view of the apparatus according to one embodiment of FIG. 1a;

FIG. 1c is a perspective view of the machine of FIG. 1a shown with its front door open;

FIGS. 1d-1h are a set of skeleton views of the machine of FIGS. 1a and 1c showing internal components according to an embodiment;

FIG. 2 is an exemplary flow chart of actions performed to receive and cook a package of food using the machine of FIG. 1a according to an embodiment;

FIGS. 3a-3n are a series of side skeleton views of the machine of FIG. 1a showing positioning of internal components for a cooking cycle of food from a package according to an embodiment;

FIGS. 4a-4e are a set of skeleton views of the machine of FIGS. 1a and 1b showing internal ventilation features according to an embodiment; and

FIGS. 5a-5c are a set of skeleton views of the machine of FIGS. 1a and 1b showing internal cleaning features according to an embodiment.

### DETAILED DESCRIPTION OF AN EMBODIMENT

The description which follows, and the embodiments described therein, are provided by way of illustration of an example, or examples, of particular embodiments of principles of the present disclosure. These examples are provided for the purposes of explanation, and not limitation, of those principles and of the disclosure. In the description, which follows, like parts are marked throughout the specification and the drawings with the same respective reference numerals.

For reference, directional terms such as “left”, “right”, “top”, “bottom”, “up”, “upward”, “down” and “downward” describe locations/positions relative to a user facing the front of an embodiment (i.e. the frying machine), unless otherwise noted or otherwise made plain by the context of the use of the term. Such reference terms are not necessarily limiting unless made plain by the context of the use of the term.

Briefly, an embodiment provides a machine that will cook individually sized portions of oil-fried food products from pre-packaged food items. A target deployment for an embodiment is in a smaller footprint retailer, such as a convenience store, a gas station, or the like, where counter space is limited. An embodiment also provides features for ease of use, tracking of products, and streamlined maintenance.

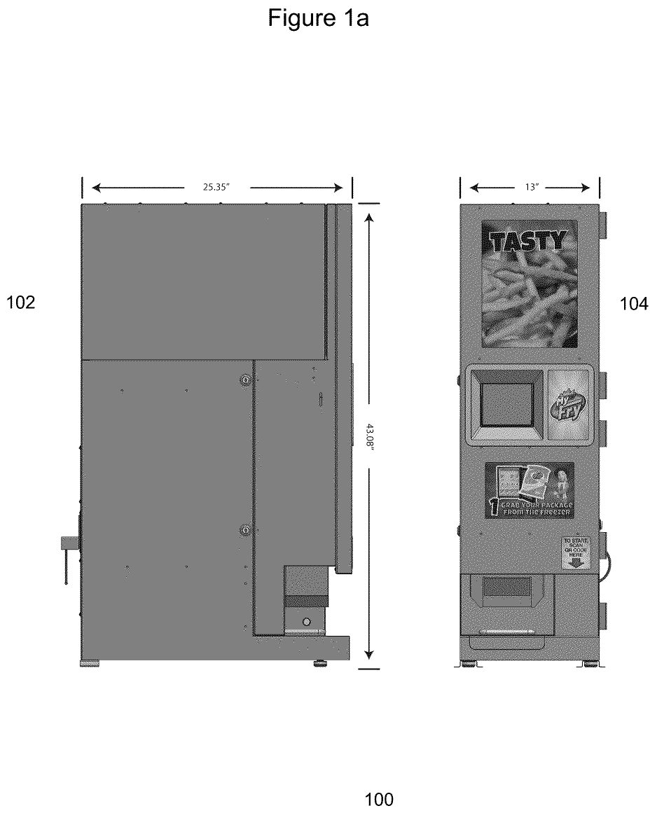

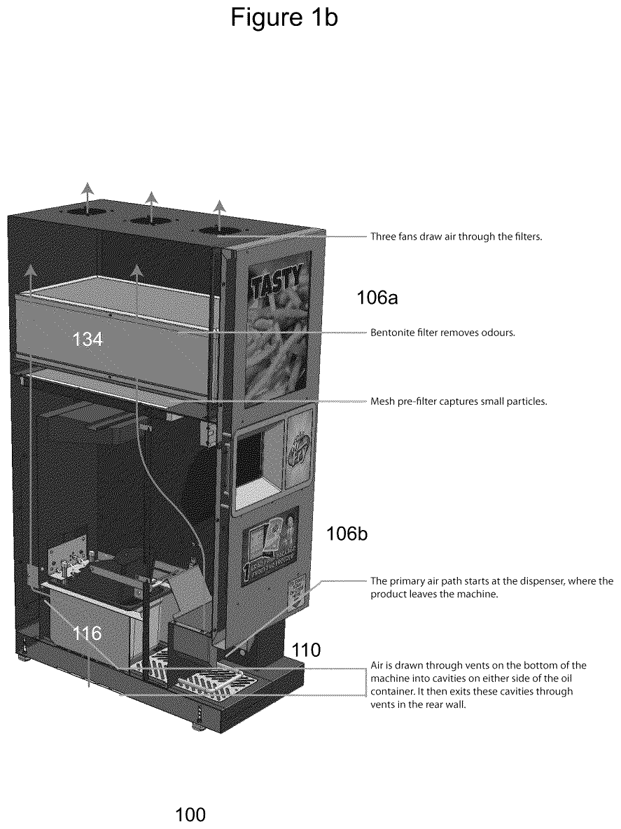

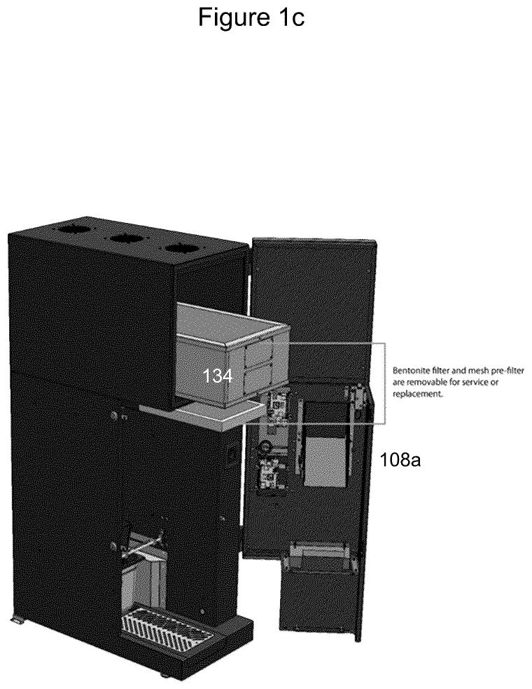

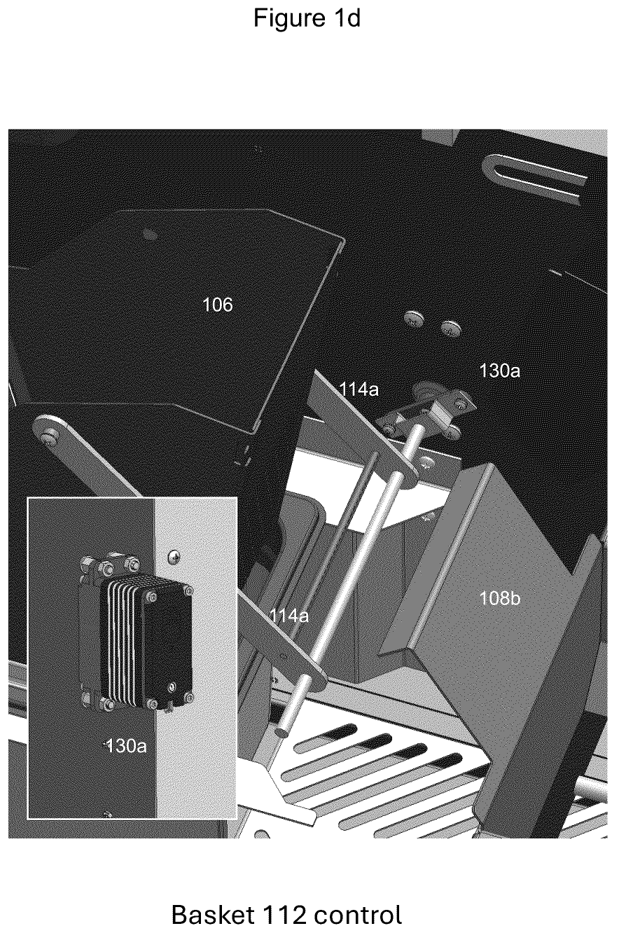

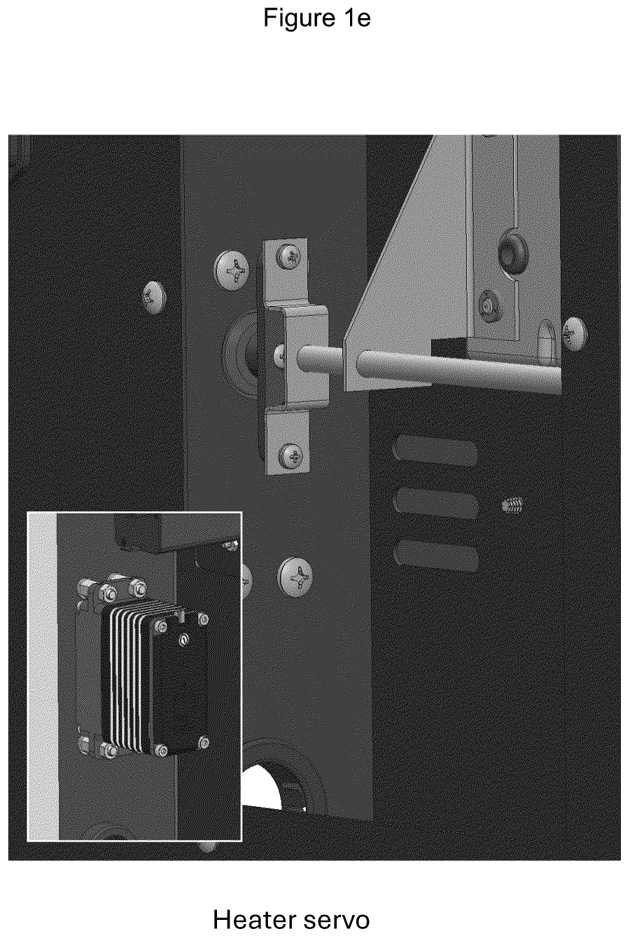

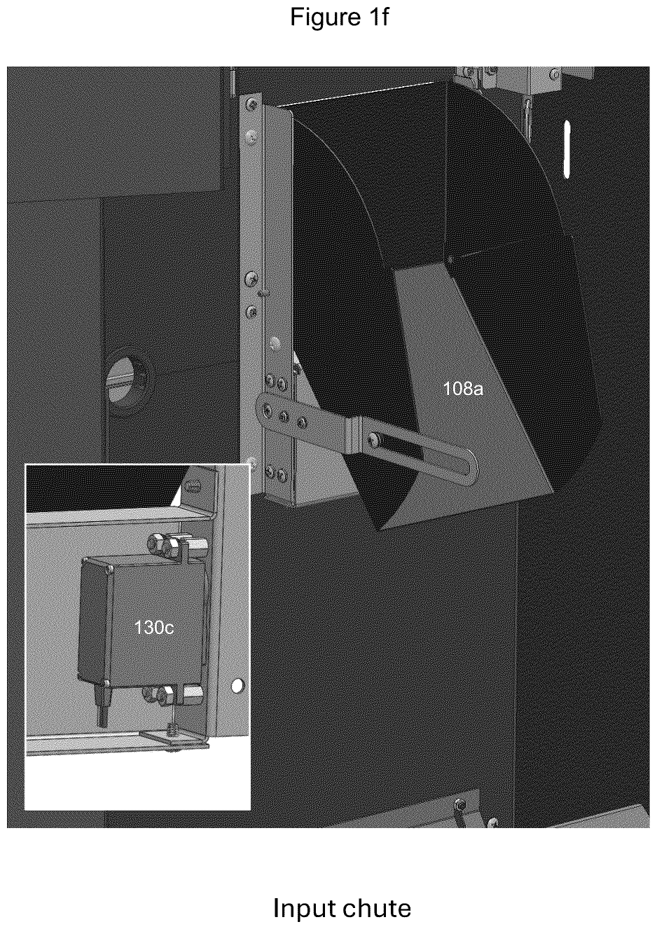

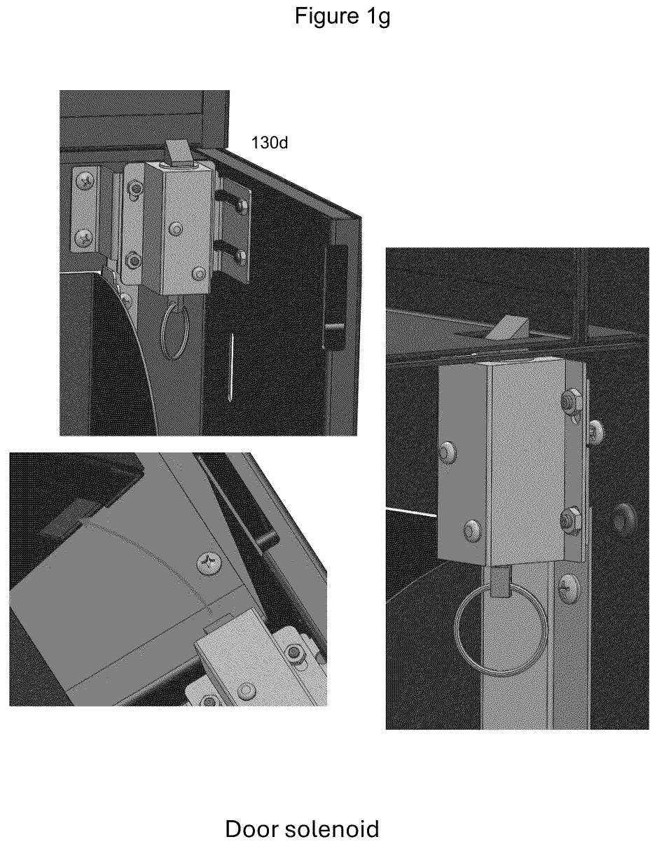

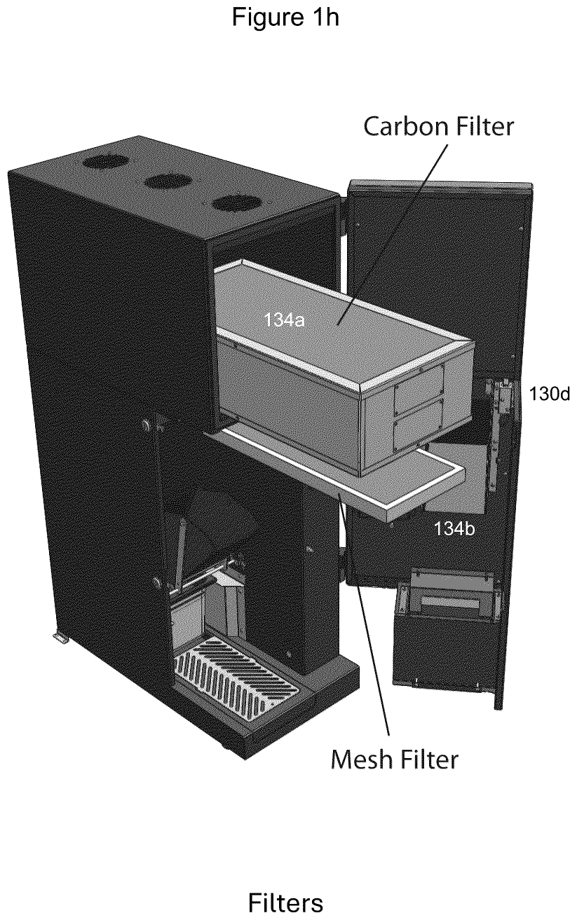

FIGS. 1a-1g collectively show a frying machine of an embodiment of the disclosure from a front view. Frying machine 100 is shown, with case 102 comprising front door 104 hingedly attached to case 102. In front door 104 there are displays 106 (one or both of which may be a touchscreen), chutes/slides 108, and delivery area 110. Door 104 is hingedly attached to case 102. Case 102 has internal walls and structures to provide physical support for internal components and to provide air channels to support venting (as described below). Case 102 and certain components are made of metal, in order to be durable and to retain structural integrity in view of the cooking temperatures and heated oil processed by machine 100. Within case 102 operating components of machine 100 are positioned and mounted including fryer basket 112 with arms 114a, internal structures of input door and chute 108a, oil pan 116, heating coil unit 118, and sensors 128. Basket 112 is movably connected to articulated arms 114a, where the shape and positioning of arms 114a relative to basket 112 and case 102 permit basket 112 to be moved and placed at various locations and orientations within machine 100 during cooking and clearing cycles. Movement and locating of basket 112 are provided by servomotor 130a connected via a rod to a joint where arms 114a meet (as shown), so that when servomotor 130a is actuated (rotating in either its clockwise or counterclockwise directions), arms 114a are moved, thereby moving basket 112 to various positions. Heating coil unit 118 comprises heating coil 120, thermostats 122 that are mounted on bracket 124, which is movably connected to arms 114b and servomotor 130b, whose actuations in conjunction with the shape of arms 114b permit coil unit 118 to be moved and placed at various orientations within the volume of pan 116 and above pan 116 during cooking and clearing cycles. Also provided are control module 126 controlling and receiving data from servomotors/solenoids 130, coil unit 118, sensors 128, fans 132 (located on top side of machine 100), air filter system 134 (located within machine 100), and optical reader 148. Further details on control module 126 are provided later, but briefly module 126 is a microprocessor-controlled package of electronics having hardware, firmware and software to receive input signals from components in machine 100, gather and process data, and generate output control signals for components to implement cooking cycles, cleaning cycles, data analysis cycles, maintenance cycles, and other cycles for machine 100.

In a typical deployment, machine 100 is located at a retailer site (e.g. a convenience store, a grocery store, a gas station, etc.), typically on a counter with suitable space around it to permit sufficient ventilation, and connections to power, water, and external communication networks (wired and/or wireless). Machine 100 provides a compact counter footprint by vertically stacking oil pan 116, filtration system 134 and fans 132. One embodiment provides a footprint of approximately 15 inches wide, 25 inches deep, and 40 inches tall with dimensions for filters being approximately 11 inches wide by 23 inches deep, and 6 inches thick.

Within the retailer, a supply of pre-packaged food products is stored, typically within a refrigerator or freezer. The packages may contain different items and flavours (e.g. French fries, normal cut, waffle fries, mini corn dogs, etc.). The labelling on each package identifies its contents and cooking instructions. A computer readable code (e.g. a bar code or QR code) is typically also printed on the package. The code encodes information about the product (specific product, size, etc.).

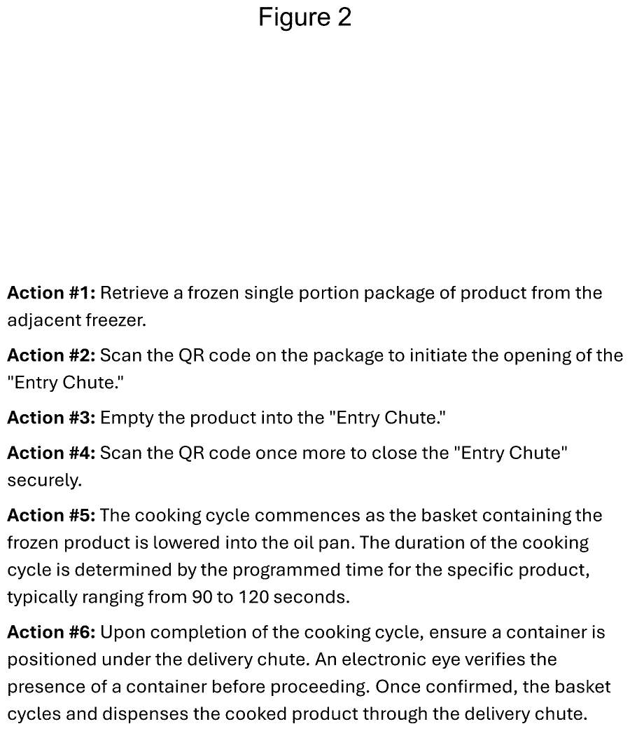

In a typical customer transaction, a customer selects and a package of food products, takes it to machine 100 and either manually initiates a cooking cycle for the product or presents the code on package 150a to reader 148 on machine 100. Per FIG. 2, flow chart 200 shows typical actions conducted by the customer and machine 100 including:
Retrieving a food products package from an adjacent freezer;
At machine 100, scanning the QR/bar code on package 150a, which then identifies the product to machine 100, which in turn identifies a cooking cycle for the product;
Starting a cooking cycle for the product, first by activating servomotor 130c to position door/chute 108a to an open position (with a corresponding message displayed on display 106), per FIG. 1f;
Emptying product 150b from package 150a into chute 108a, causing the product to slide down chute 108a to be deposited into basket 112, which is located within machine 100 at a first location to receive the product;
Closing chute 108a (in one embodiment activated by scanning QR/bar code again);
At that instance, machine 100 will then autonomously move basket 112 to be submersed in oil in pan 116, to cook the product for a predetermined amount of time (per the identified cooking cycle), then raise basket 112 above pan 116, then move basket 112 to a position to dispense the cooked product from basket 112, once machine 100 detects that a paper container 144 has been placed in the dispensation area in machine 100.

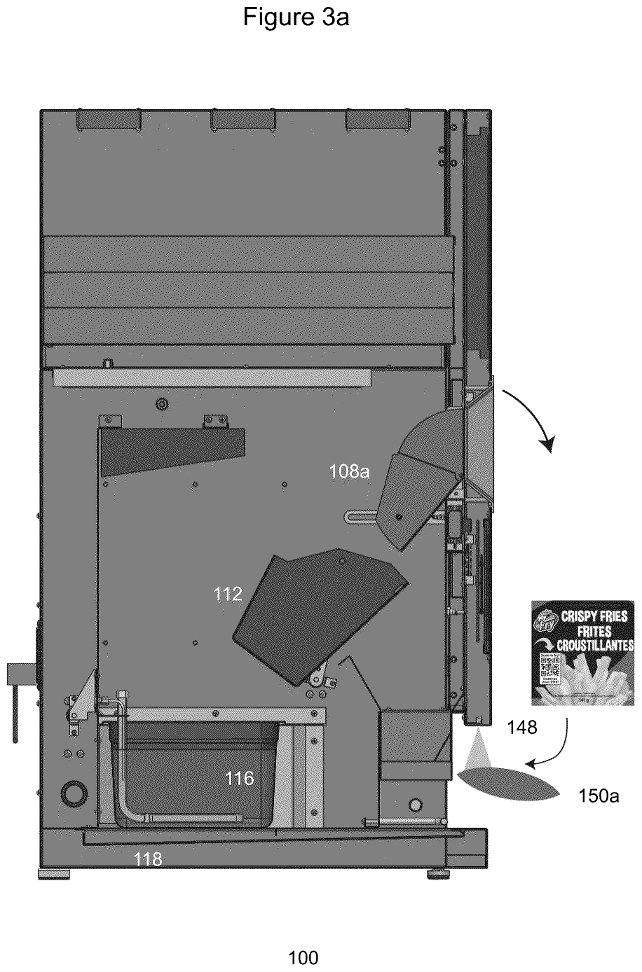

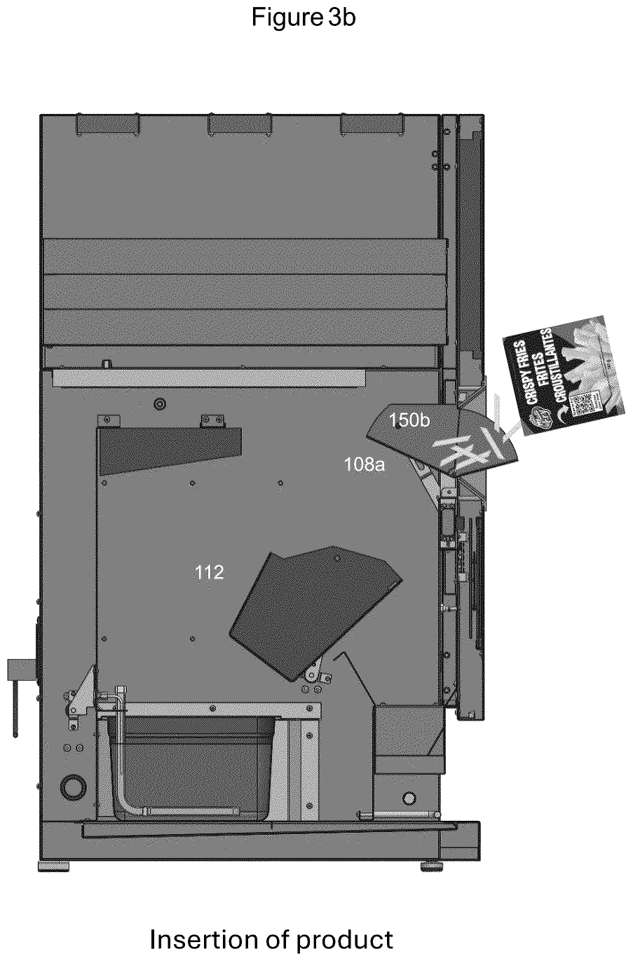

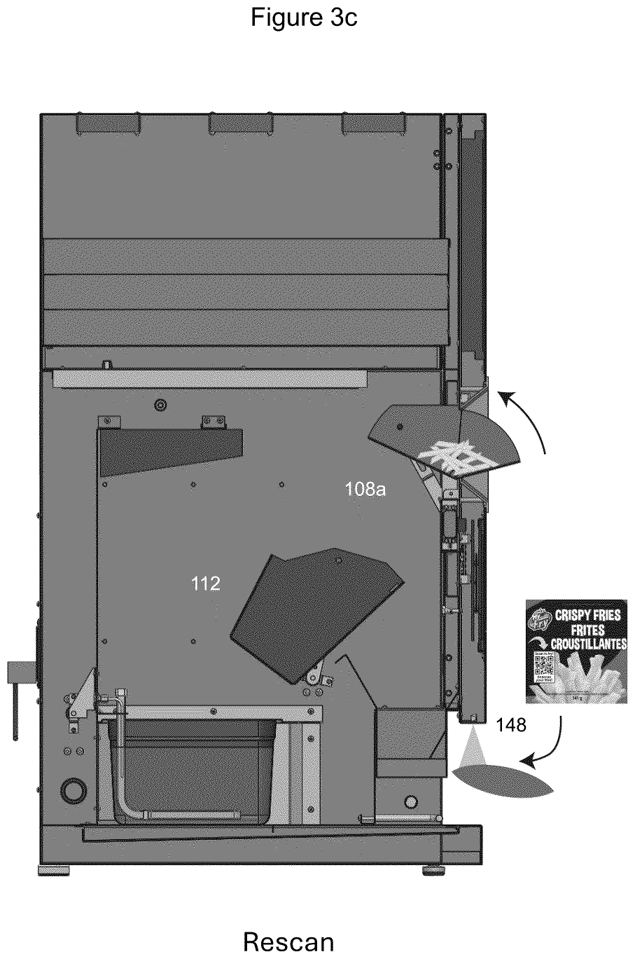

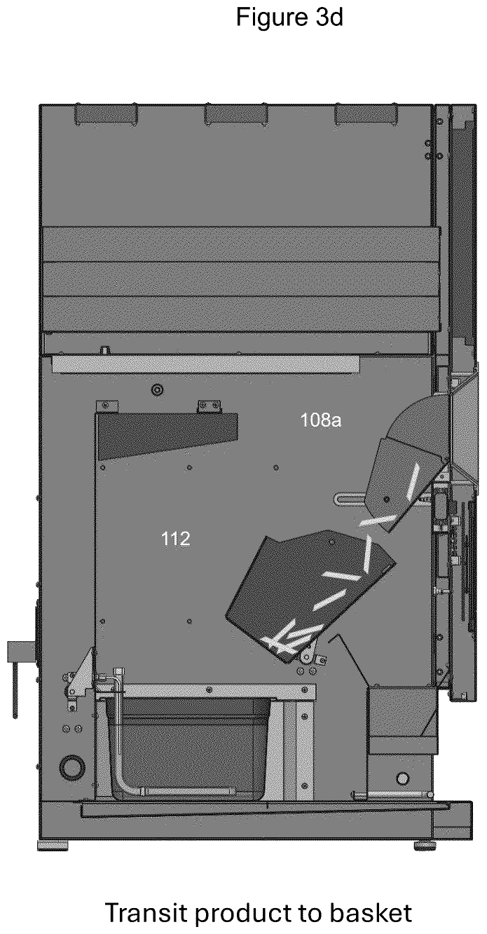

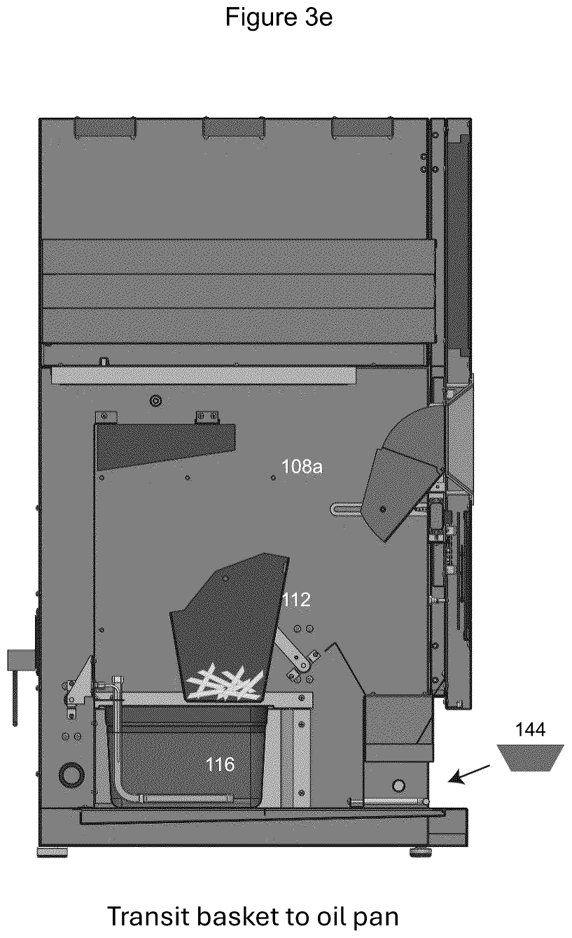

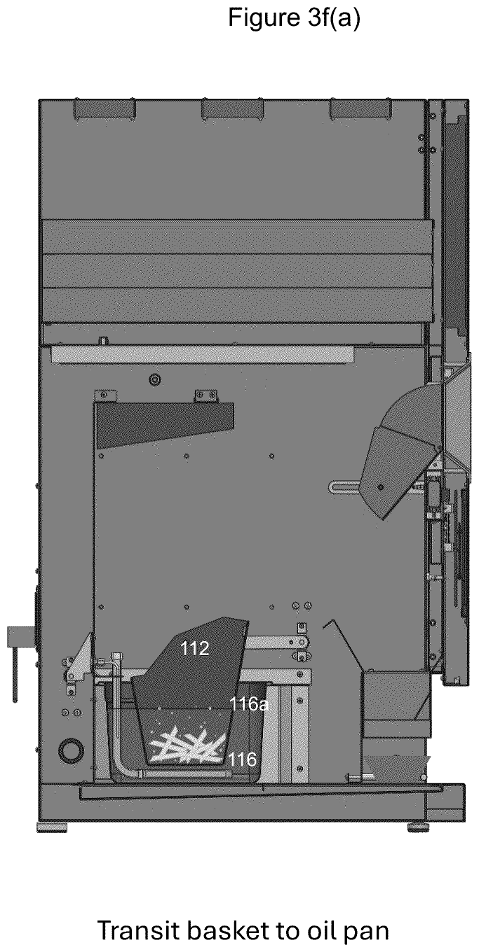

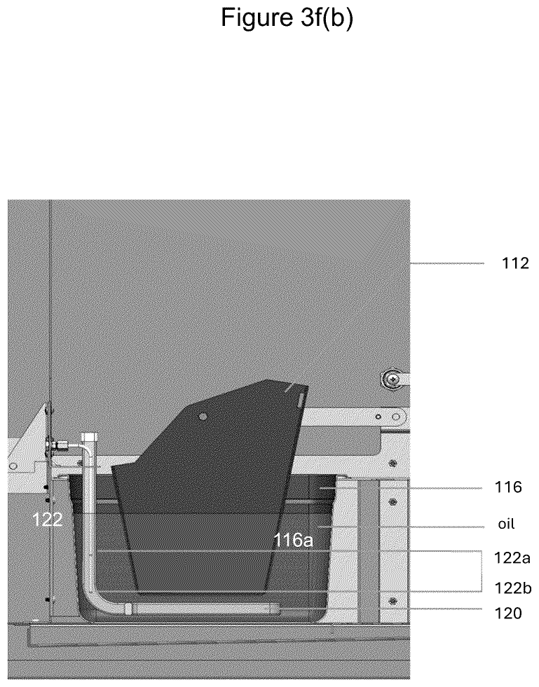

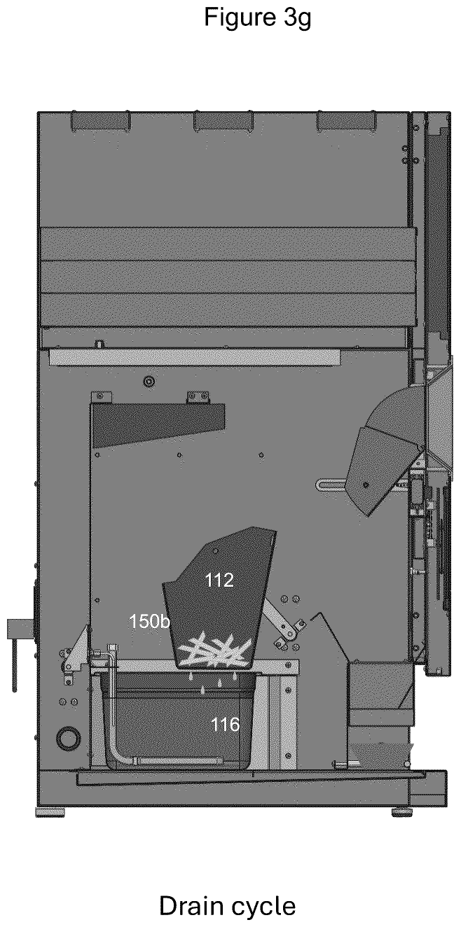

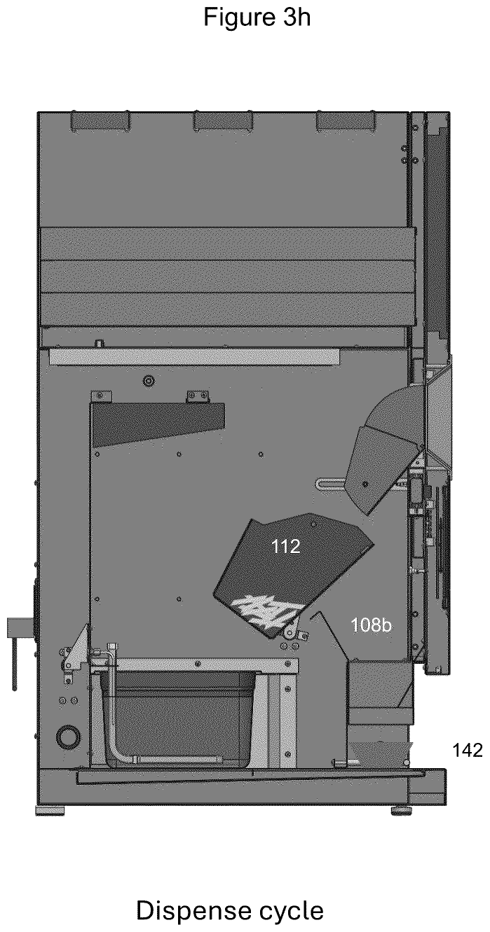

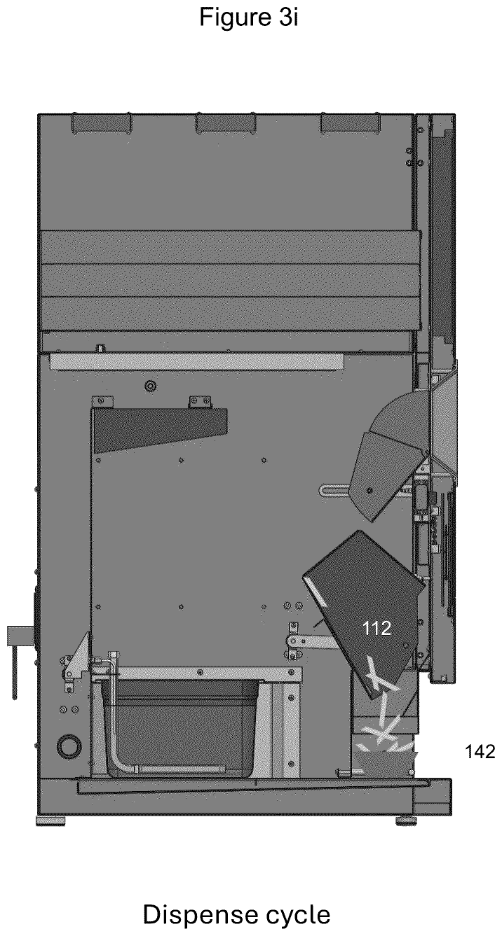

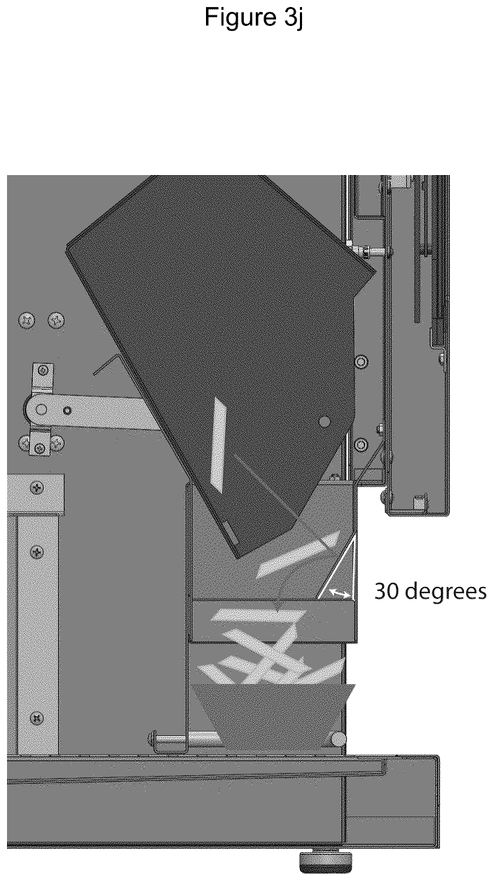

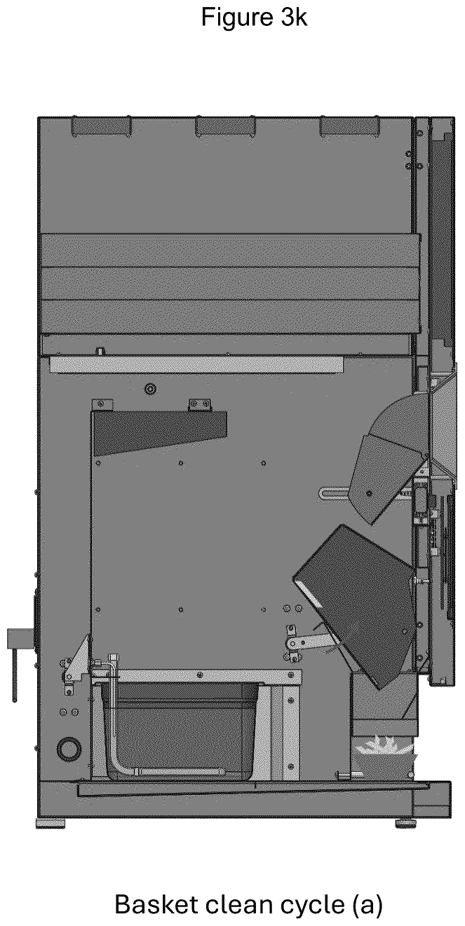

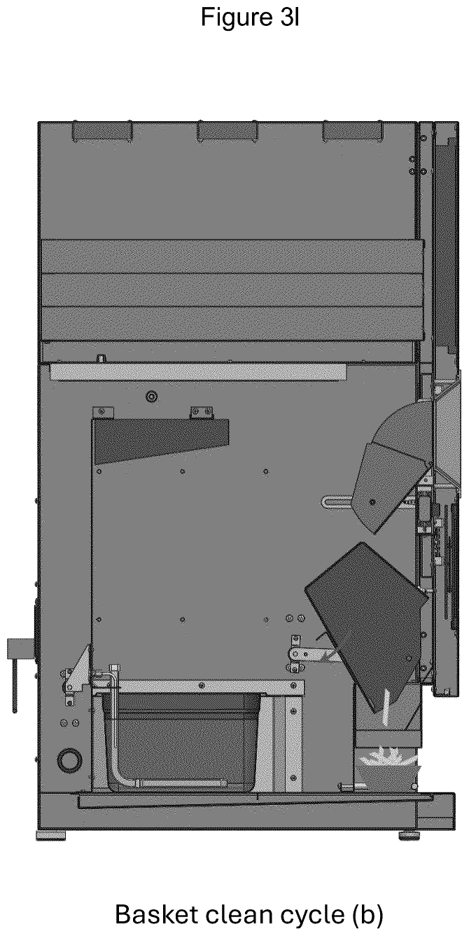

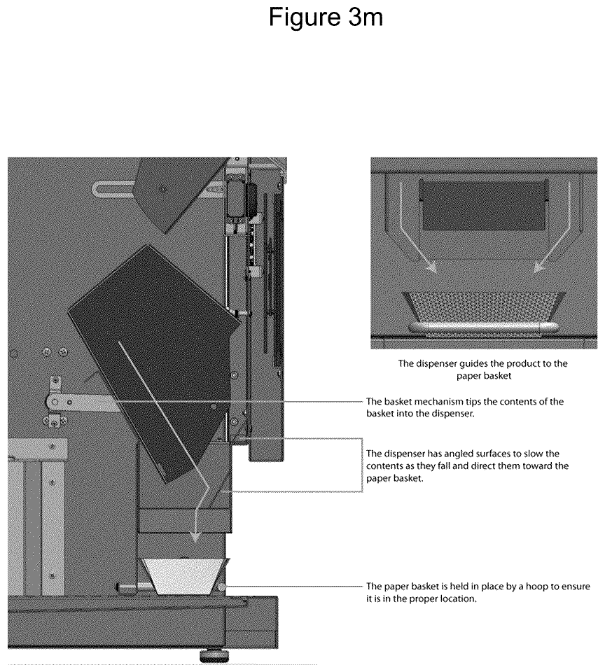

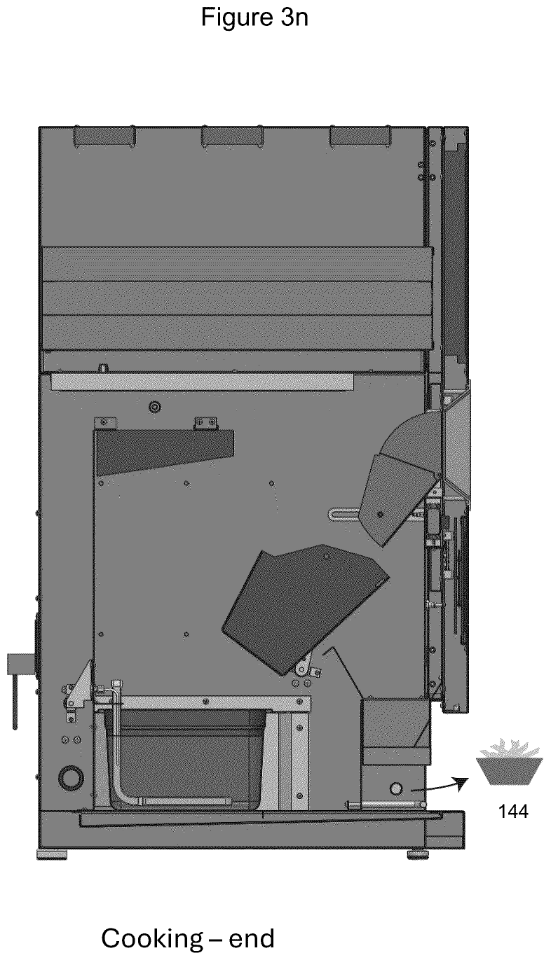

FIG. 2 provides more details on processing and cooking actions for a product and FIGS. 3a-3n illustrate features of a typical cooking cycle for a product is shown, where:
FIG. 3a shows machine 100 and its components in a standby mode;
FIG. 3b shows machine 100 in a product scan mode;
FIG. 3c shows machine 100 a product dispensing to hopper mode;
FIG. 3d shows machine 100 in a hopper close mode;
FIG. 3e shows machine 100 in a paper basket dispense mode;
FIG. 3f(a) and (b) show machine 100 in a product cooking mode;
FIG. 3g shows machine 100 in a cooking completion mode;
FIGS. 3h-3j show machine 100 in a product dispense mode;
FIGS. 3k-3m show machine 100 in a basket clean mode; and
FIG. 3n shows machine 100 in a product finished mode (effectively the standby mode).

An exemplary cooking cycle commences with a user bringing a package of uncooked products to machine 100 and scanning it under reader 148. Module 126 activates and controls reader 148 to read and recognize the code on the package. Once the code is recognized, machine 100 information on the product, its size, its cooking parameters, and other information, collectively contained as data in a recipe for the product. Such information may be encoded in the code or may be stored in a related database accessed by module 126. At this time, appropriate module 126 may generate and display initial product information and initial instructions on display 106. Module 126 will position basket 112 at a first location to receive the product and open door 104 to allow the product to be dispensing into machine 100 down the related chute. Movement and locating of basket 112 are controlled by module 126 by receiving inputs and generating and sending motor movement instructions to servomotor 130a for controlling movement of basket 112.

Once the product has been received from chute 108a, the associated door is closed by module 126 and cooking of product can be initiated. To cook the product, basket 112 is moved from the first location to a second cooking location which is in oil pan 116 containing a volume of cooking oil 116a.

Oil pan 116 has a volume capacity to hold approximately 3 L of cooking oil. Module 126 controls the activation of coil 120, monitoring of signals from thermostats 122, and the positioning of coil unit 118 and basket 112 in pan 116. The duration of the cooking cycle is determined by the recipe for the product, typically ranging from between about ninety (90) and one hundred and twenty (120) seconds. While cooking, appropriate text, graphics, and/or video information can be displayed on display 106 as controlled by module 126.

For convenience and immediacy, coil 120 is activated at all normal operating times while at the location (e.g. during the “store” hours of the retailer), so that oil in pan 116 is maintained at a suitable cooking temperature at any time an order is placed, which is advantageous in a fast-food or convenience food retailer where reduced cooking times are desirable. In one embodiment, coil 120 is rated at 2100 watts. Some power-saving modes may temporarily turn off coil unit 118 or reduce its operating temperature. Thermostats 122a and 122b are in communication with module 126 to provide temperature information at various locations within pan 116. Other sensors 128 monitor other ambient and operational conditions in machine 100 (e.g. the air temperature of various ambient locations in machine 100, the presence of “stuck” food items at various locations within machine 100, etc.).

After completion of the cooking cycle, basket 112 is moved from the second location in pan 116 to a third location located out of and above oil pan 116.

To reduce the transfer of heat from pan 116 to the exterior walls of machine 100, additional internal walls 138, are located on either side of the container. Walls 138 create an air pocket, effectively mitigating temperature transfer to the exterior frame of machine 100 and maintaining cooler exterior surfaces.

At the third location, basket 112 is located above pan 116 and is maintained at that location for a brief period of time, in the range of a few seconds (e.g. approximately 1 to 5 or more seconds). This positioning allows excess oil in basket 112 to drip back into pan 116. Basket 112 is perforated on its bottom (and/or the bottom is made of wire) to permit any cooking oil on product in basket 112 to drop off the product and through the perforations back into pan 116. Module 126 also controls servomotor 130a to generate micro back and forth oscillations to cause basket 112 to be jiggled at the third location, thereby agitating the product in basket 112, to assist with removing oil from the product and draining the oil back to pan 116.

At the third location, after draining oil from basket 112, the product is cooked and any further product processing may be performed as determined by the recipe and any additional components in machine 100 (e.g. automatic salting of product by machine 100 by a seasoning module (not shown) that contains appropriate seasoning and that can be positioning about basket 112 at the third location (or a different location if determined by the recipe) and can dispense a predetermined amount of seasoning).

After cooking and any seasoning of the product, product is ready to be dispensed from machine 100. For dispensing product, container 144 must be in position in delivery area 110. Module 126 determines from signals from sensor whether a container 144 is positioned under delivery chute 108. An electronic sensor 128 determines the presence of container before proceeding. Once confirmed, basket 112 moves from the third location to a fourth location, which tilts basket 112 forward and downward to chute 108, as such product in basket 112 falls downward out of basket 112 and is dispensed from basket 112 out through delivery chute 108 to the container. To assist in the movement of cooked product along chute 108, it may be coated with a friction reducing compound, such as Teflon™. Deflector plate 146 is located on the interior front wall of machine 100 across from the mouth of basket 112 when basket 112 is dispensing the cooked product to chute 108. Deflector plate 146 is positioned at an angle of approximately 30° from vertical, which further facilitates delivery of products (and non-sticking of the products to the chute) from basket 112 through to container 144.

As part of the product dispensing cycle, per FIGS. 3k and 3l, basket 112, Module 126 also controls servomotor 130a to generate micro back and forth oscillations to cause basket 112 to be jiggled at the fourth location, to provide a further physical agitation to basket 112 to dislodge any potentially stuck product in basket 112.

At this time, the cooking cycle is complete, and the user can retrieve the package containing the cooked products and module 126 controls servomotor 130a to return basket 112 to the first position.

It will be seen that in one embodiment, food delivery ordering and processing by machine 100 is “touchless”, where the consumer does not need to press buttons or controls on machine 100 to initiate and then collect a food order, thereby promoting hygiene.

Further details are provided on additional features of embodiments.

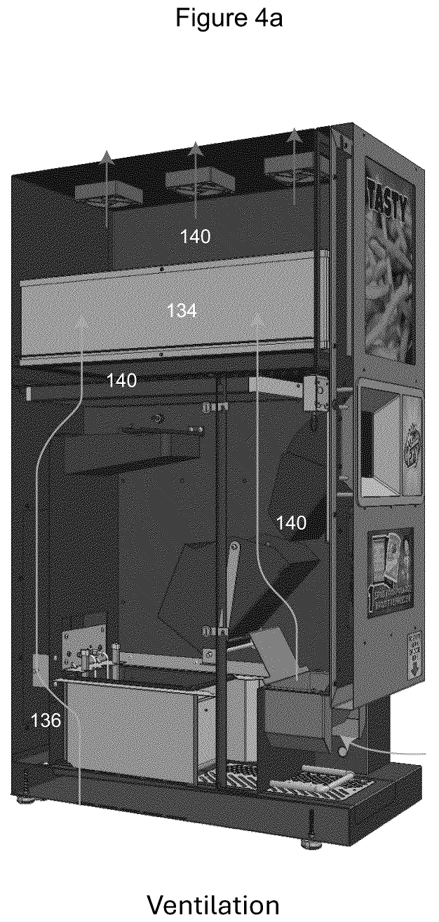

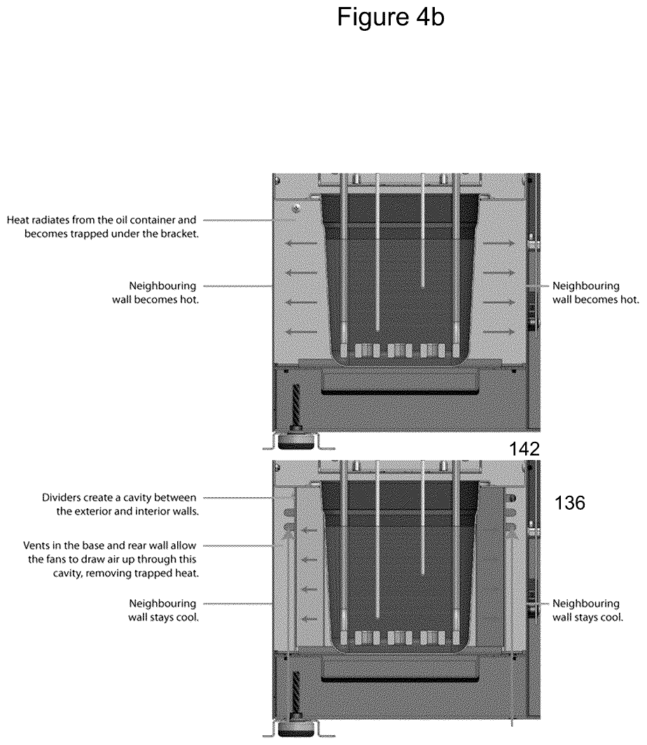

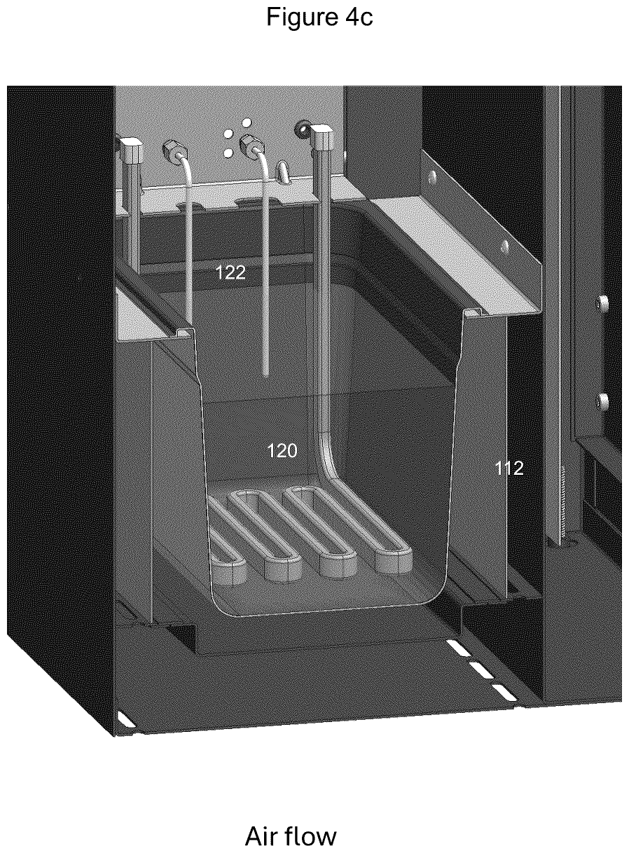

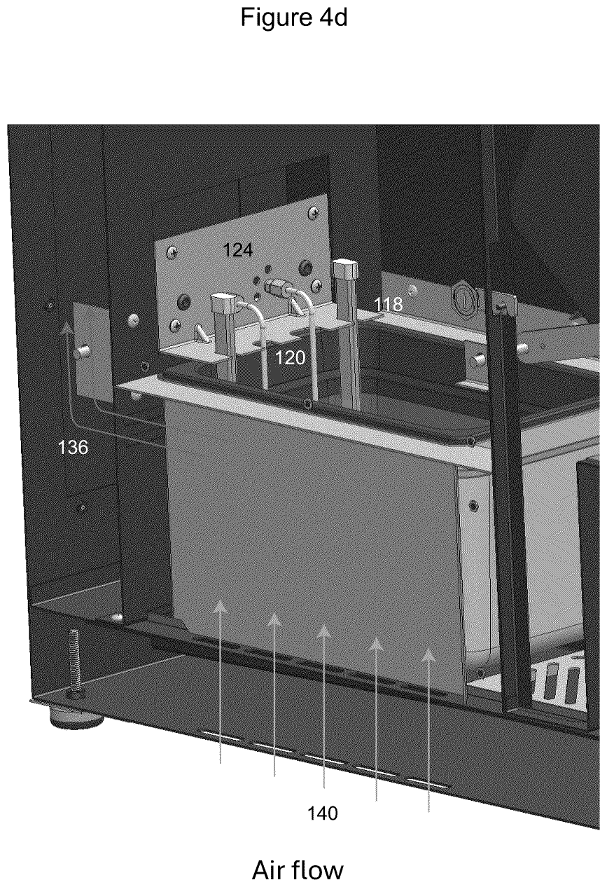

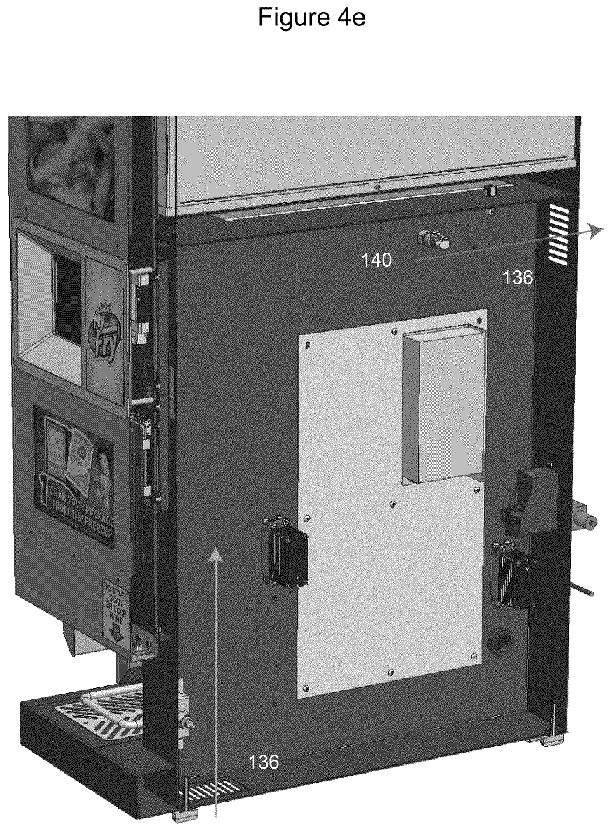

Referring to FIG. 1b and FIGS. 4a-4e, one feature provided by an embodiment is air circulation and filtration system 134, which removes cooking particles and related odours from ambient air contained within machine 100 during the cooking process before such air exits machine 100 to the exterior atmosphere. FIG. 4b shows ambient air temperatures around pan 116 and walls 138 through red arrows (hot air) and blue arrows (cooler air).

FIG. 1b shows operating aspects of air filtration system 134 utilizing fans 132 and vents 136 within machine 100 to provide a robust flow of air upward originating from intake vents 136 on the bottom of machine 100, upward through airflow 136 on side channels 142 beside oil pan 116 (FIG. 8), extending along the side of the exterior walls of case 102, upward through air filtration system 134, through fans 132 and exhausting out of top of machine 100.

For an exemplary cooking cycle, When the cook cycle begins, fans 132 are operated at the fast/very fast speeds, to encourage air flow in machine 100 to force existing ambient air around oil pan 116, which may contain vapours or cooking odours through filtration.

Vents 136 are strategically placed within inside machine 100 to mitigate heat buildup around oil pan 116 and to facilitate an optimal path for airflow 140 through filtration system 134.

In an embodiment, three fans 132 are provided which are controlled by control module 126 and when operating, draw airflow 140 out of internal cooking compartment within machine 100, creating a negative pressure environment. This suction effect ensures that air is effectively circulated through filtration system 134. More of less fans may be deployed. A different number of fans can be deployed for different machines. Operation of fans 132 are controlled by module 126.

In one embodiment, fans 132 are continuously operating, but the specific operating speeds (e.g. off, very slow, slow, medium, fast, very fast, etc.) may be controlled by module 126.

For an exemplary cooking cycle, when the cooking cycle begins, fans 132 are operated at the fast/very fast speeds, to encourage air flow in machine 100 to force existing ambient air around oil pan 116, which may contain vapours or cooking odours through filtration.

Air filtration system 134 provides two air filtration elements, vertically stacked. Lower filtration element 134a contains activated charcoal to absorb odors and contaminants from airflow 140. One embodiment provides approximately 2 inch depth of charcoal. The charcoal can be replaced. Above element 134a is an air gap to facilitate upwards movement of airflow 140 and to enhance filtration performance. In one embodiment, the air gap is approximately 2 inches. Above the air gap is an upper filtration element 134b also contains activated charcoal and is also at a depth of approximately 2 inches. Mesh filter 134 c is located below filtration element 134a so that it captures from airflow 140 moist vapor droplets suspended therein. Mesh filter 134c provides a secondary barrier to larger particulate contaminants (perhaps produced during the cooking cycle) suspended in airflow 140. Mesh filter may be washable, typically with warm water and soap, simplifying maintenance and facilitating optimal filtration performance over time. Each filter is removable from machine 100 for individual maintenance and repair.

With filtration system 134, it may be possible to reduce a need to additional exterior ventilation and related equipment (e.g. ventilation hoods).

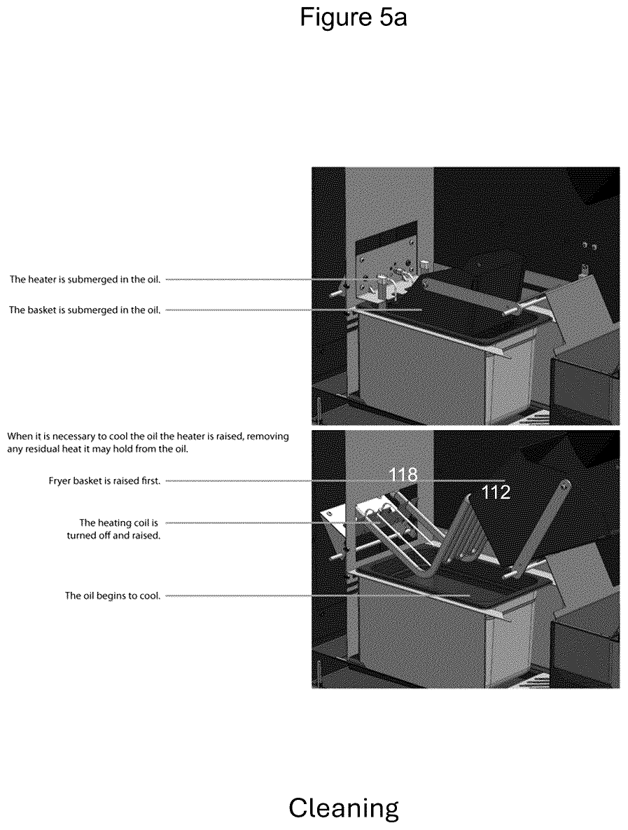

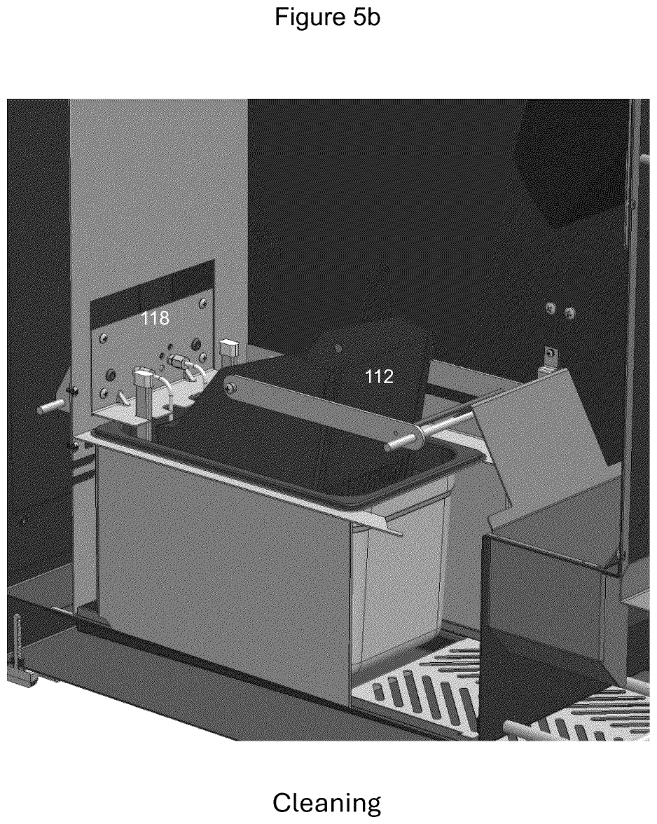

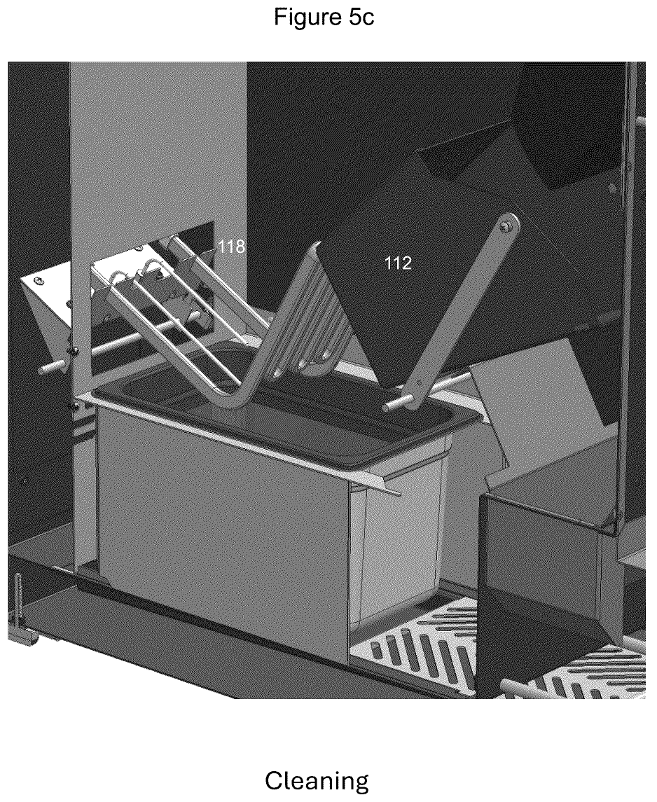

An embodiment provides a “change oil” and a “shut down” cycle. For either cycle it is desirable to cool down oil 116a in pan 116 as quickly as possible. In a typical retail environment, it has been determined that for a 3 L amount of cooking oil, it is preferable to change the oil approximately either every 3 to 4 days or after over completion of approximately 125 cooking cycles (which every occurs first). An embodiment tracks time and cooking cycles since at last change and once a threshold has been exceeded (either time or cooking cycles), machine 100 may automatically prompt the retailer to change the oil in pan 116. As part of an oil change cycle, an electronic solenoid lock 130d on door 104 is activated to engage with a mating latch in the chassis of machine 100 (to prevent the retailer from accessing the inside of machine 100), coil unit 118 is positioned to move coil 120 and thermostats 122 out of pan 116, to allow oil 116a to start to cool. Once the internal temperature in machine 100 has dropped to a deemed safe internal temperature (either through a temperature reading or through a predetermined passage of time), lock 130d is deactivated, allowing door 104 to be opened to access inside machine 100. At that time, basket 112 is in a position to be cleaned and pan 116 can be slid out to be emptied and washed out. Interior components of machine 100 may be wiped down with a damp cloth, oil 116a may be replaced in pan 116 and then door 104 may be closed so that machine 100 is then ready to continue operating. During the “change oil” cycle display 106 may show appropriate text and messages on the change oil cycle. FIG. 5a shows coil unit 118 moved by activating its servomotor 130b by module 126 to move it up and out of pan 116. Basket 112 is positioned by module 126 to the second location to drain oil therefrom. Module 126 turns off the power to coil 120.

An embodiment provides monitoring of certain conditions and status checks through signals provided by thermostats 122 and sensors 128. Associated with pan 116 and the oil, one embodiment provides three sensors 122a, 122b and 122c. Thermostats 122a and 122b are in coil unit 118. Thermostats 122a and 122b are positioned to be located at different heights in pan 116; one is lower and one is placed higher. This permits machine 100 to continuously monitor the temperature of oil 116a in pan 116 and levels of oil 116a. For example, if the lower thermostat 122a is calculating an expected temperature of heated oil and the higher thermostat 122b is not, that indicates that the level of oil 116a is below the higher thermostat (i.e. low) and machine 100 can then initiate a shut down cycle and notify the retailer to that the retailer will top up the oil. Another thermostat 122d is located within the lower bars of the coil unit 118 so that the heater will not turn on at all if there is no oil in pan 116. Other sensors 128 may include optical sensors, weight sensors, trigger sensors, etc. that may be positioned along the product processing path within machine 100 to monitor for and detect except states (e.g. detect that food is stuck along the path or that basket 112 is jammed for some reason).

It will be seen that the combination of machine 100 and the on-hand variety of pre-packages products provides a retailer with access to a wide variety of foods that can be prepared by machine 100. Module 126 will track usage of products (each having packages with separate SKUs and unique QR/bar codes) and provides reports to the retailer on popularities of products and reordering schedules. These features are helpful in retail locations where a lower volume of sales of such fried products is traditionally expected (e.g. non-fast food environments). Different products can be introduced and tested with minimal up front expenses.

Control module 126 is a CPU-controlled module that is connected to various input/output (I/O) devices within machine 100, including display 106, fans 132, servomotors 130 and sensors 128. Generally, module 126 may be implemented as computing module having commercially available processor(s) with related components and memory.

For machine 100, one or more processes operating on module 126 provide instructions to its processor to execute commands and data transactions implementing features of an embodiment performed by machine 100. The memory may have a database storing information about a history of products processed by machine 100 and their cooking instructions, numbers of cooking and cleaning cycles, parts replacement histories and other operational and maintenance records (e.g. tracking changing of oil, filters, and other maintenance cycles). Module 126 may be connectable to exterior remote systems and have processing for controlling transfer of data between the remote systems (including point of sale cash registers) and updating software. Data may be transmitted from machine 100 to a remote site, such as a head office, where global data from multiple machines may be collected, product usage data at particular locations analyzed, and specific cleaning/maintenance instructions may be sent to specific machines. Additionally, data may be transferred to a point of sale terminal at the retail location to indicate the sale and pricing information to the terminal for processing when the user leaves the retailer with the cooked product.

Although the processes, services and modules described herein are implemented in software operating on machine 100, it will be appreciated that some or all functions of these processes may be provided in a separate device(s) or server(s) that communicate with machine 100. It is not required that module 126 perform only functions as described above. As such, specific functionalities for module 126 or process may be moved between processes or separated into different processes. Processes may be contained within other processes. Different signaling techniques may be used to communicate information between applications using known programming techniques. Known data storage, access and update algorithms allow data to be shared between applications. Known database algorithms, mathematical algorithms, such as order processing algorithms, database update algorithms, and others, may be implemented using programming techniques known in the art.

It will be appreciated that alternative embodiments may use different mechanical features and devices to move and position components described herein (e.g. using belts, gears, motors, and pulleys instead of or in addition to servomotors and slides). As well, specific locations of basket within machine 100 during various cycles (e.g. first, second, third connected to features describing aspects of embodiments as being “mountable”, “attachable”, “vertical”, “parallel”, “aligned”, or in other terms relating to relative position or orientation have a range of acceptable implementations, values or positions that, if provided, still provide a functional embodiment. For example, a component described as being “mountable” will have suitable physical shape(s) and dimension(s) enabling it to be mounted related to its intended position; and a component described as having “vertical” or “parallel” element(s) will encompass elements that are substantially vertical or parallel. As a further example, if two components are described as being “parallel” in orientation, other embodiments will tolerate the two components being aligned in a nearly parallel fashion (where the description may use the term “generally parallel”). Similarly, if a component is described as being “aligned”, other embodiments will tolerate a component being nearly aligned. It will be plainly obvious to a person of skill in the art as to what range of values would be acceptable.

In this disclosure, where a threshold or dimension is provided as an approximate value (for example, when a dimension or threshold is qualified with the term “approximately”), a range of values will be understood to be valid for that value. For example, for a dimension stated as an approximate value, a range of about 25% larger and 25% smaller than the stated value may be used. Thresholds, values, measurements, and dimensions of features are illustrative of embodiments and are not limiting unless noted. Further, a “sufficient” designation (e.g. a sufficient size) may mean having dimensions or values that provide a minimum amount of material or size to achieve a stated function of the related parameter.

In this disclosure, where the conjunction “and/or” is used to end a list of elements, it will be understood that its use indicates an “inclusive or” of the listed elements. As such, the phrase “X and/or Y” means “(X or Y) or (both X and Y)”.

Although the disclosure has been described with reference to certain specific embodiments, various modifications thereof will be apparent to those skilled in the art without departing from the scope of the disclosure as outlined in the claims appended hereto.

1. A machine for frying food at a retail location, the machine comprising:
an optical reader to scan and read a product code from a package of food products;
a display;
a chute to receive the food products from the package;
an oil pan;
a heating coil unit locatable within the oil pan and moveable to a location away from the oil pan;
a first motor connected to the heating coil unit to controllably move the heating coli unit;
a moveable basket to receive the food products from the chute, the basket moveable amongst
a first location within the machine to receive the food products;
a second location to be immersed within oil in the oil pan for cooking the food products;
a third location to be raised above the oil pan after the food products are cooked; and
a fourth location to dispense the cooked food products to a container;
a second motor connected to arms connected to the basket to controllably move the basket;
a control module to
control the first motor to set the location of the heating coil;
control the second motor to set the location and movements of the moveable basket;
track and monitor oil usage; and
track and monitor food products processed over a period of time.
wherein
the package of food products is one variety in a plurality of packages of food products.

2. The machine for frying food as claimed in claim 1, further comprising:
an air ventilation and cleaning system comprising
first and second filters; and
a mesh filter;
a plurality of fans; and
a series of air vents and channels along the cabinet walls of the machine to facilitate air flow within the machine.

3. The machine for frying food as claimed in claim 1, where the control module further:
controls the activation of the coils to keep the coils activated during opening business hours for the retail location.

4. The machine for frying food as claimed in claim 1, where the control module further:
controls the second motor when the basket is at the third location raised above the oil pan after the food products to hold the basket at the third location to facilitate excess oil on the products to drain from the basket.

5. The machine for frying food as claimed in claim 1, where the control module further:
controls the second motor when the basket is at the fourth location dispensing the cooked food products to the container to oscillate the basket back and forth about the fourth location to cause any stuck food products to fall from the basket.

6. The machine for frying food as claimed in claim 1, where the heating coil unit comprises:
a heating coil;
a first thermostat positionable at a first depth in the oil pan; and
a second thermostat positionable at a second depth in the oil pan,
wherein
the control module analyzes temperature readings from the first and second thermostats to determine a level of oil in the oil pan.

7. The machine for frying food as claimed in claim 1, where the control module further:
has a cleaning cycle for the machine, the cleaning cycle
monitoring for a threshold of either a time since last cleaning and cycles of food products processed is since the last cleaning;
upon the threshold being reached, starting the cleaning cycle by:
activating a lock for a front door of the machine;
displaying a message on the display indicating that the cleaning cycle has been initiated;
lifting the heating coil unit out of the oil pan;
turning off the heating coil unit; and
starting a timer to track the cooling time for the oil;
and
upon a threshold of time being passed for the timer
deactivating the lock for the front door; and
displaying a message on the display indicating that the cleaning cycle completed.

8. The machine for frying food as claimed in claim 1, where the control module further:
generates a report of the food products processed over the period of time; and
transmits the report to a remote location over a communication link.

9. The machine for frying food as claimed in claim 1, where the control module further:
tracks for operating error conditions in the machine; and
transmits an error condition report to a remote location over a communication link.

10. The machine for frying food as claimed in claim 1, where the control module further:
generates a sales report of the food product currently being processed; and
transmits the report to a point of sales terminal location over a communication link.
